(19) United States
(12) Patent Application Publication
(10) Pub. No.: US 2026/0148450 A1
(43) Pub. Date: May 28, 2026

(54) STORAGE MEDIUM, INFORMATION PROCESSING APPARATUS, AND METHOD FOR CONTROLLING INFORMATION PROCESSING APPARATUS

(71) Applicant: CANON KABUSHIKI KAISHA, Tokyo (JP)

(72) Inventor: YASUKO KATO, Kanagawa (JP)

(21) Appl. No.: 19/397,731

(22) Filed: Nov. 21, 2025

(30) Foreign Application Priority Data
Nov. 26, 2024 (JP) 2024-205613

(51) Int. Cl. G06T 11/60; G06F 3/04847

(52) U.S. Cl. CPC G06T 11/60; G06F 3/04847

(57) ABSTRACT

A non-transitory computer-readable storage medium stores a program of an application for causing an information processing apparatus to execute a method. The method comprises changing a size of an editing area of editing data in response to a change in a size of a printing medium used to output the editing data in the application, the editing data containing a first object and a second object different from the first object; and performing control to notify that the first object and the second object overlap in a case where the first object and the second object overlap as the size of the editing area is changed by the changing.

### BACKGROUND

### Field of the Technology

The present disclosure relates to a storage medium, an information processing apparatus, and a method for controlling an information processing apparatus.

### Description of the Related Art

There have recently become available print product creation applications capable of creating print products, such as posters, by generating print data based on editing data obtained by combining objects such as images, text, and two-dimensional codes on a single canvas displayed for review. Such a print product creation application allows the size of editing data containing a plurality of objects to be resized to fit any printing medium size before printing.

Patent Document (Japanese Patent Laid-Open No. 2019-537807) discloses a method for defining frame size and position adjustment rules for frames corresponding to objects, in order to adapt each object contained in editing data to various printing medium sizes as the printing medium size is changed.

There is a demand for a method for adjusting the layout of overlapping objects contained in editing data in a print product creation application.

### SUMMARY

A storage medium according to an aspect of the present disclosure is a non-transitory computer-readable storage medium storing a program of an application for causing an information processing apparatus to execute a method. The method comprises changing a size of an editing area of editing data in response to a change in a size of a printing medium used to output the editing data in the application, the editing data containing a first object and a second object different from the first object; and performing control to notify that the first object and the second object overlap in a case where the first object and the second object overlap as the size of the editing area is changed by the changing.

Features of various embodiments of the present disclosure will become apparent from the following description of embodiments with reference to the attached drawings. The following description of embodiments are described by way of example.

### BRIEF DESCRIPTION OF THE DRAWINGS

FIG. 1 is a diagram showing a configuration example of a system including an information processing apparatus.

FIG. 2 is a diagram showing an example of an editing screen for a Web application.

FIG. 3 is a diagram showing an example of the editing screen for the Web application.

FIG. 4 is a diagram showing an example of the editing screen for the Web application.

FIG. 5 is a diagram showing an example of the editing screen for the Web application.

FIG. 6 is a diagram showing an example of the editing screen for the Web application.

FIG. 7 is a diagram showing an example of the editing screen for the Web application.

FIG. 8 is a diagram showing an example of the editing screen for the Web application.

FIG. 9 is a flowchart showing an example of a flow for resizing an object in the Web application.

FIG. 10 is a diagram showing an example of a method for saving and managing objects contained in editing data.

FIG. 11 is a flowchart showing an example of a flow for selecting erasure candidates in the Web application.

FIG. 12 is a diagram showing an example of a method for saving and managing coordinates of the objects contained in the editing data.

FIG. 13 is a diagram showing an example of a poster created based on a template and object attributes preset for objects contained in the template.

FIG. 14 is a diagram showing an example of a method for saving and managing priorities according to the object attributes.

FIG. 15 is a diagram showing an example of the editing screen for the Web application in a state where a settings screen for setting the priorities corresponding to the object attributes is displayed.

### DESCRIPTION OF THE EMBODIMENTS

Preferred embodiments of the present disclosure will be described in detail below with reference to the accompanying drawings. Note that the following embodiments do not limit the scope of every embodiment, and not all combinations of features described in the following embodiments are necessarily essential to the solutions of the present disclosure. Note that the same components will be denoted by the same reference numerals.

There is a technology of the related art that allows for resizing of a printing medium by restricting the size and position of each object upon resizing editing data containing a plurality of objects in a print product creation application to a given size of the printing medium. However, in a case where the size of the printing medium is reduced, resizing the editing data to maintain the readability of objects, such as text and two-dimensional codes, can result in overlapping objects, which can disrupt the layout of the editing data.

In the following embodiments, description will be given of a technology for adjusting the layout of overlapping objects contained in editing data in a print product creation application.

### First Embodiment

### Information Processing Apparatus

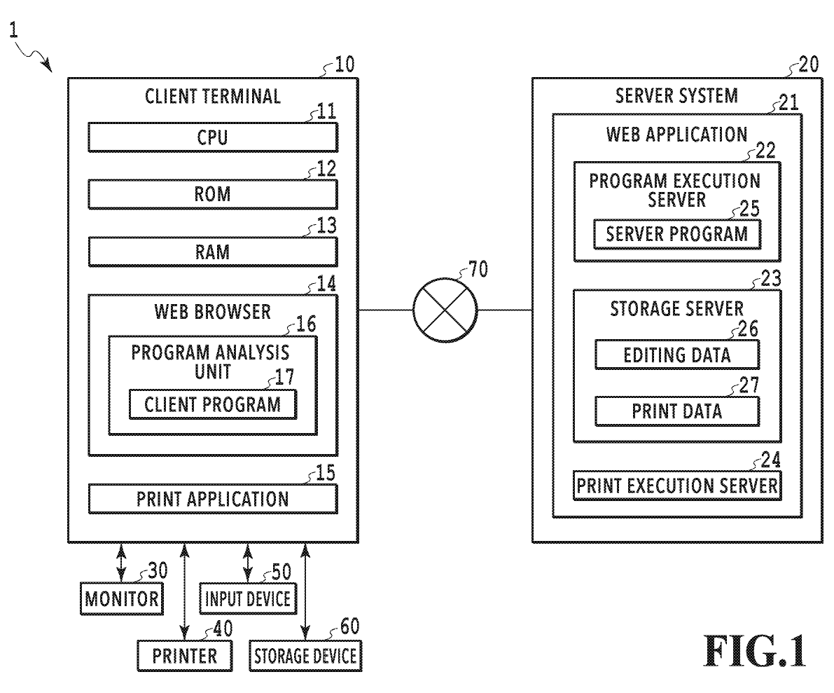

FIG. 1 is a diagram showing a configuration example of a system 1 in the present embodiment. The system 1 includes a client terminal 10 and a server system 20. With reference to FIG. 1, configurations of the client terminal 10 and the server system 20 in the present embodiment will be described.

The server system 20 is a server configured to provide a Web application 21. The server system 20 includes information processing apparatuses such as a program execution server 22, a storage server 23, and a print execution server 24. The program execution server 22 executes a server program 25, which is a program that runs on the server system 20. The storage server 23 stores editing data 26, such as image files for the Web application 21, and print data 27, such as print data files. The print data 27 includes data generated based on the editing data 26, for example.

The print execution server 24 sends the print data 27 to the client terminal 10. Printing is performed by a printer 40 to be described later based on the print data 27 received by the client terminal 10. The program execution server 22, the storage server 23, and the print execution server 24 may be implemented as physically separate apparatuses or as a single apparatus.

The client terminal 10 is an information processing apparatus. In the present embodiment, the client terminal 10 is described as a personal computer, but the client terminal 10 is not limited thereto. For example, the client terminal 10 may be an information processing apparatus such as a tablet terminal or a smartphone.

The client terminal 10 includes a CPU 11, a ROM 12, a RAM 13, a Web browser 14, and a print application 15. The client terminal 10 has a storage (not shown) for storing programs, such as the Web browser 14, the print application 15, and an operating system (OS), but is not limited thereto. For example, these programs may be stored in a storage device 60 to be described later.

The client terminal 10 includes an input/output interface (not shown) for connecting to a monitor 30, the printer 40, an input device 50, and the storage device 60. The client terminal 10 also includes a network interface (not shown) for connecting to a network 70, such as the Internet.

The CPU 11 is a central processing unit configured to control the entire client terminal 10 by executing the OS stored in the storage or the like. The CPU 11 also implements various functions of the client terminal 10 by executing the Web browser 14, the print application 15, and other programs stored in the storage or the like. For example, the CPU 11 can change and output obtained data and also control the respective hardware components, based on input information.

The ROM 12 is a read-only memory and stores various programs, such as a boot program. The RAM 13 is a main memory of the client terminal 10 and is used as a work memory of the CPU 11. Note that if the RAM 13 is a non-volatile RAM, it can retain stored programs even if the client terminal 10 is powered off. The Web browser 14 enables browsing of Websites on the Internet and can execute the Web application 21. Upon executing the Web application 21, the Web browser 14 receives a client program 17 from the server system 20 and uses a program analysis unit 16 to interpret HTML (Hyper Text Markup Language) and the like. The print application 15 sends the print data 27 to the printer 40 connected directly to the client terminal 10 or via a network.

### Web Application

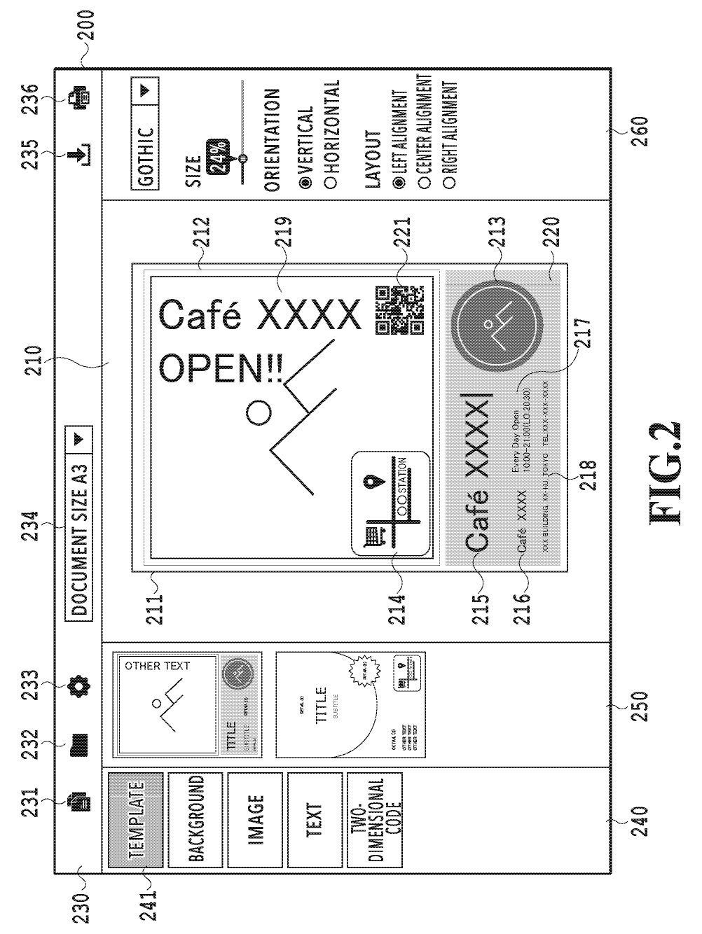

FIGS. 2 to 8 are diagrams each showing an example of an editing screen for the Web application 21 running on the Web browser 14. With reference to FIGS. 2 to 8, processing performed by the Web application 21 in the present embodiment will be described. In the present embodiment, description will be given of an example where the Web application 21 is a poster creation application.

FIG. 2 is a diagram showing an example of an editing screen 200 for a poster creation application, which is the Web application 21 running on the Web browser 14, for editing the editing data 26 containing objects. In the present embodiment, the editing data 26 refers to data that can be edited on the Web application 21. The editing data 26 contains a plurality of objects constituting an image, such as a poster, for example. A user can create desired editing data by editing the objects via the editing screen of the Web application 21. Note that editing in the present embodiment includes making changes to objects constituting a “template” to be described later and includes placing new objects on a newly created canvas.

The editing screen 200 has a review display area 210 for displaying a preview of a poster that is currently being edited by the user, a button display area 230, an object selection area 240, an object display area 250, and a settings area 260.

The review display area 210 displays editing data representing a poster currently being edited, with an object 211 representing a background. The editing data includes objects 211 to 221. The objects 212 to 214 are objects representing images. The objects 215 to 219 are objects representing text. The object 220 is an object representing clip art. The object 221 is an object representing a two-dimensional code. Example of the two-dimensional code include a QR (Quick Response) code (registered trademark).

The button display area 230 includes a newly create button 231, a folder button 232, a setting button 233, a pull-down menu 234, a save button 235, and a print button 236.

The newly create button 231 is a button for receiving an instruction to create a new poster. As the user presses the newly create button 231, new editing data is generated. The folder button 232 is a button for receiving an instruction to open existing editing data. As the user presses the folder button 232, a user interface for selecting the existing editing data is opened. The setting button 233 is a button for receiving an instruction to open a settings screen. As the user presses the setting button 233, the settings screen to be described later is opened.

The pull-down menu 234 is a pull-down menu for changing the size of a printing medium used to print an image of print data generated based on the editing data. As the user presses the pull-down menu 234, a list of printing medium sizes to be described later is displayed. The save button 235 is a button for receiving an instruction to save the editing data that is being edited. As the user presses the save button 235, the editing data that is being edited is saved to a local folder provided in the storage of the client terminal 10 or to the storage server 23 of the server system 20. The print button 236 is a button for receiving an instruction to print the image. As the user presses the print button 236, the Web application 21 performs control to run the print application 15 and sends the print data generated based on the editing data to the client terminal 10. The client terminal 10 then sends the print data to the printer 40, and the printer 40 performs printing based on the received print data. If the user presses the print button 236 in a state where the print application 15 is not installed on the client terminal 10, the Web application 21 may perform control to install the print application 15.

The object selection area 240 has tabs corresponding to the types of objects to be added to the editing data being edited. FIG. 2 shows a state where a “template” tab is selected among a plurality of tabs displayed in the object selection area 240. As the user selects one of the plurality of tabs displayed in the object selection area 240, the content corresponding to the selected tab is displayed in the object display area 250.

As shown in FIG. 2, since the “template” tab is selected in the object selection area 240, a list of templates held by the Web application 21 is displayed in the object display area 250.

The setting area 260 displays detailed settings for a selected object among the objects contained in the editing data being edited. FIG. 2 shows a state where the object 215 representing text is selected. Therefore, the setting area 260 displays setting items for the font displayed in the text.

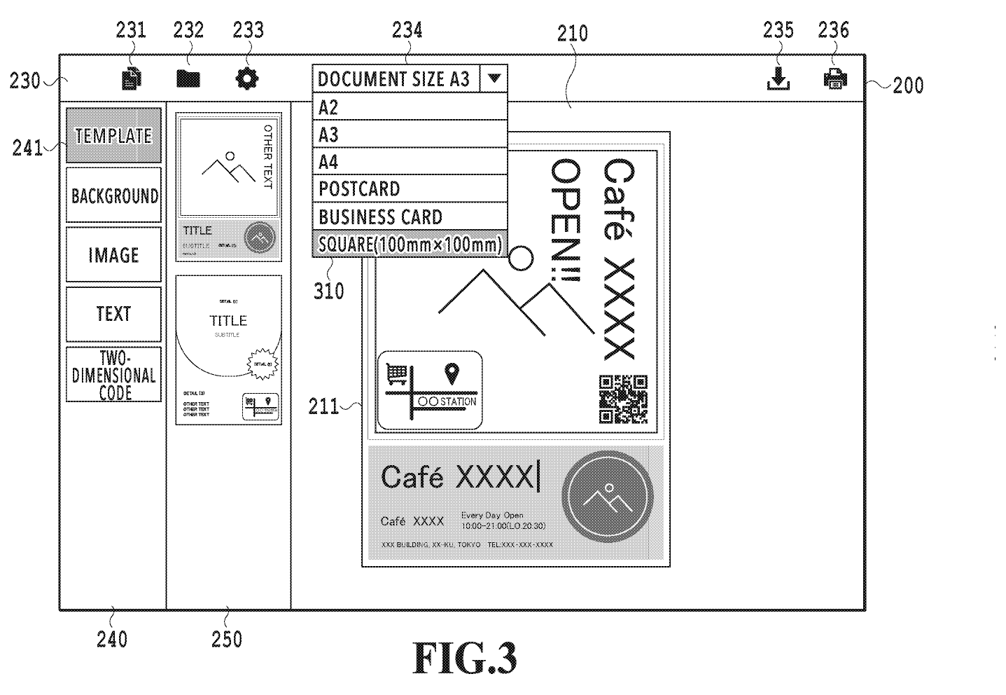

FIG. 3 is a diagram showing an example of changing the size of the printing medium used to print an image on the editing screen 200. FIG. 3 shows the editing screen 200 with a list 310 of printing medium sizes displayed. The list 310 is a list of printing medium sizes that is opened as the pull-down menu 234 is pressed in the state of the editing screen 200 shown in FIG. 2. As a given size is selected in the list 310, object resizing processing to be described later is executed.

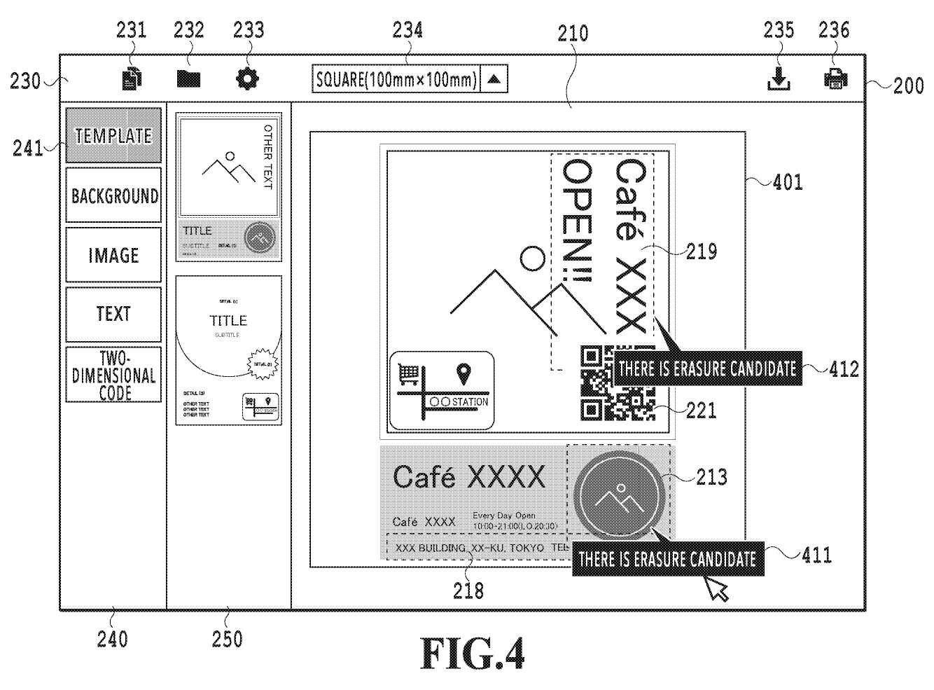

FIG. 4 is a diagram showing an example of the editing screen 200 displayed as the size “square (100mm×100mm)” is selected from the list 310 shown in FIG. 3, and the printing medium size is changed from A3 to square (100mm×100mm). In the present embodiment, description will be given of an example of changing the size of each object contained in the editing data displayed in the review display area 210 of the editing screen 200 through the object resizing processing. Specifically, the size of each object shown in FIG. 4 is smaller than the size of the corresponding object shown in FIG. 2 or FIG. 3. Note that the size of every object contained in the editing data does not have to be changed even though the object resizing processing is performed.

Also, as shown in FIG. 4, an erasure candidate notification dialog 411 is displayed in response to the overlapping objects 213 and 218, whose sizes have been changed by the object resizing processing. Furthermore, an erasure candidate notification dialog 412 is displayed in response to the overlapping objects 219 and 221.

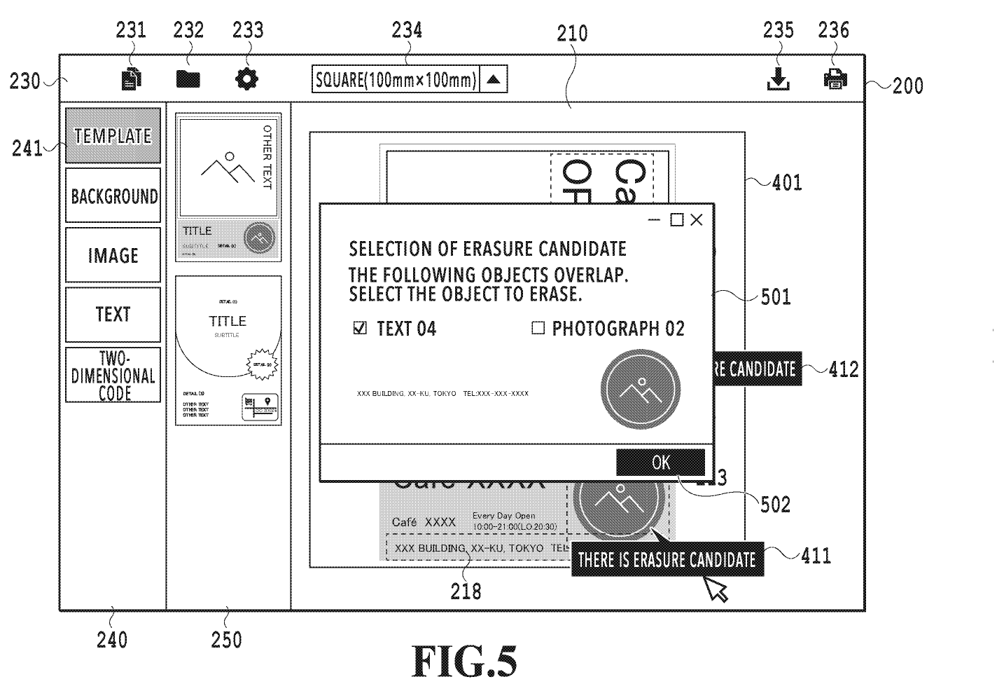

FIG. 5 is a diagram showing an example of the editing screen 200 in a state where a selection screen 501 is displayed as the erasure candidate notification dialog 411 is pressed in FIG. 4. The selection screen 501 shown in FIG. 5 is a screen displayed as the erasure candidate notification dialog 411 is pressed, and allows the user to select objects to be erased from among the overlapping objects in the editing data. The selection screen 501 displays the objects 213 and 218, which have turned into an overlapping state through the object resizing processing as erasure candidate objects. FIG. 5 shows a state where of the object 218 representing text is selected from among the overlapping objects, as the erasure candidate object. Upon detection of the pressing of an OK button 502 provided in the selection screen 501 while the object to be erased is selected, the Web application 21 closes the selection screen 501. The Web application 21 then performs processing to erase the object to be erased from the editing data.

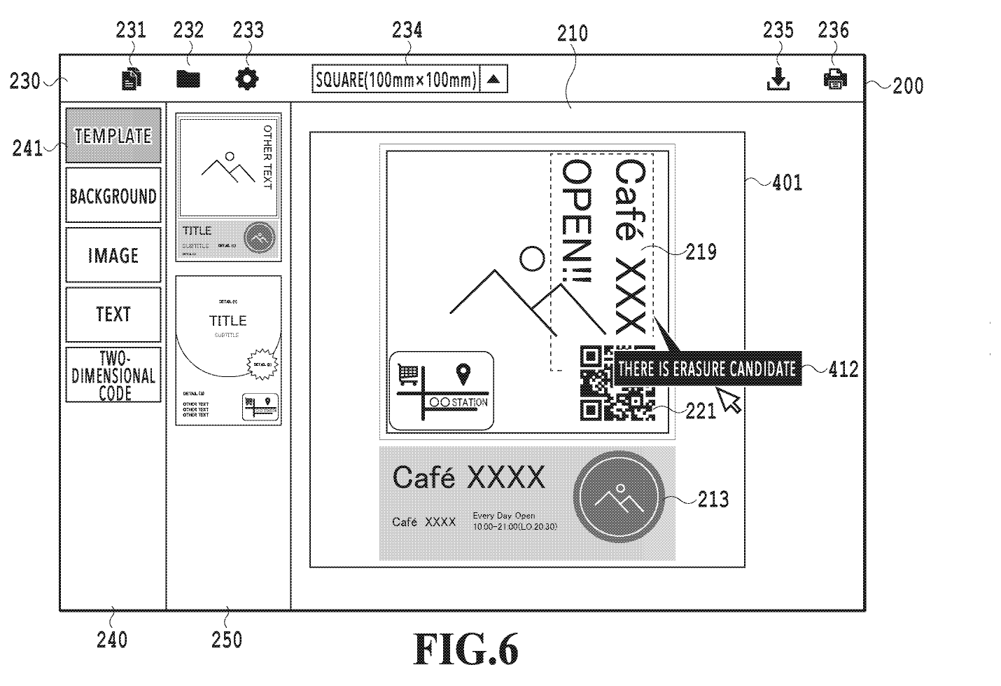

FIG. 6 is a diagram showing an example of the editing screen 200 in a state where the object 218 is selected as the object to be erased in the selection screen 501 shown in FIG. 5 and the editing data after the execution of the processing to erase the object 218 is displayed. Of the overlapping objects, the object 218 is erased, while the object 213 representing the image is retained.

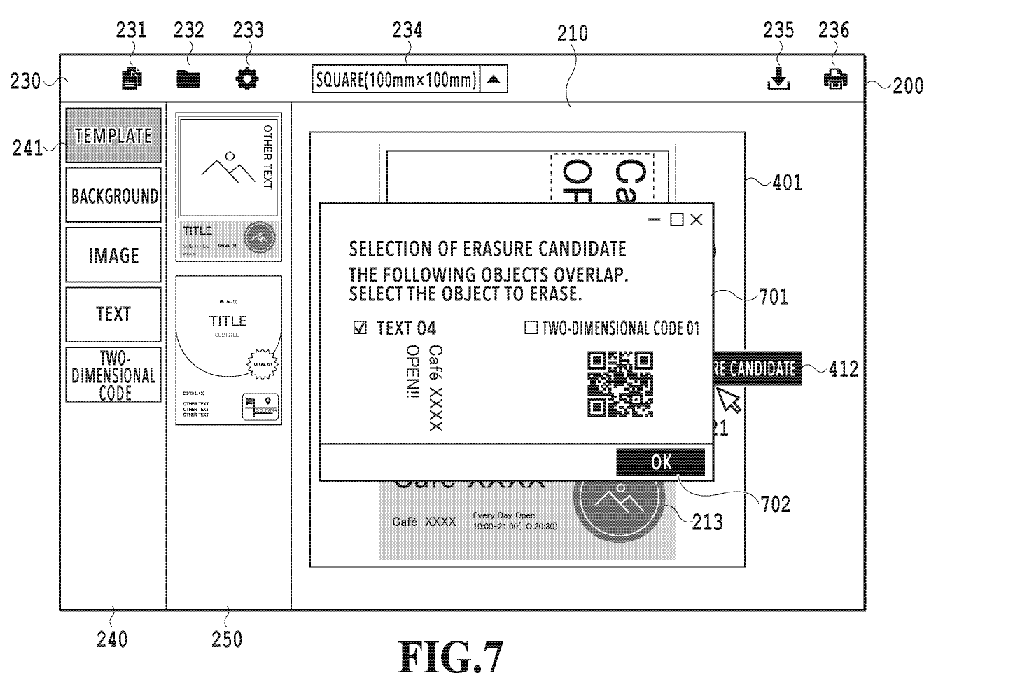

FIG. 7 is a diagram showing an example of the editing screen 200 in a state where a selection screen 701 is displayed as the erasure candidate notification dialog 412 is further pressed in FIG. 6. The selection screen 701 shown in FIG. 7 is a screen displayed as the erasure candidate notification dialog 412 is pressed and has the same function as the selection screen 501. However, the selection screen 701 displays different objects to be erased from that displayed in the selection screen 501. Specifically, the selection screen 701 displays the objects 219 and 221 that have turned into the overlapping state through the object resizing processing, as the erasure candidate objects. FIG. 7 shows a state where the object 219 representing text is selected as the object to be erased, from among the overlapping objects. As with the selection screen 501, upon detection of the pressing of an OK button 702 provided in the selection screen 701 while the object to be erased is selected, the Web application 21 closes the selection screen 701. Then, the Web application 21 performs processing to erase the object to be erased from the editing data.

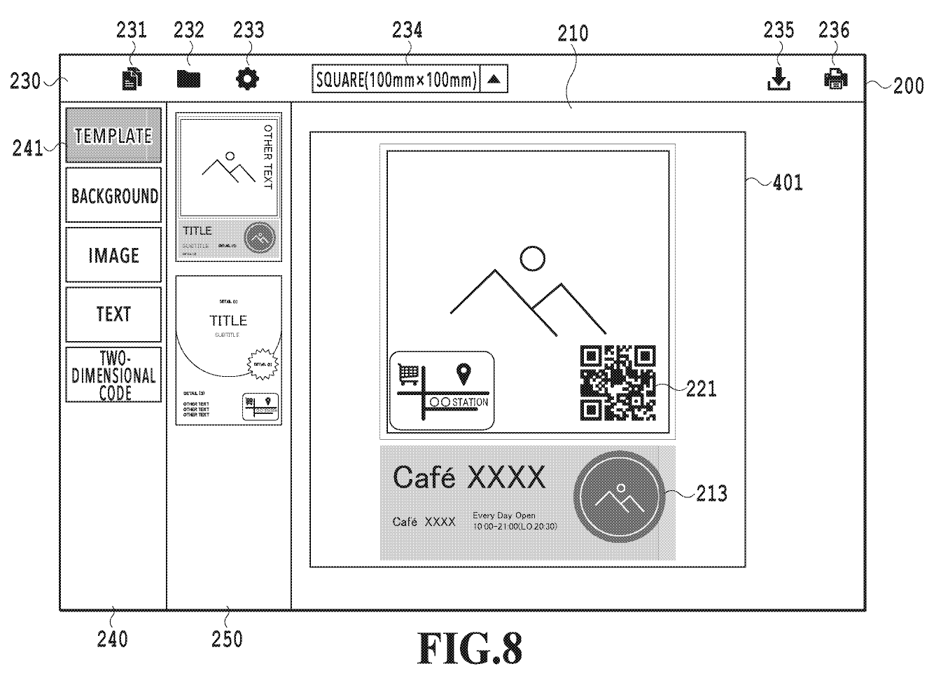

FIG. 8 shows an example of the editing screen 200 in a state where the editing data after the object 219 is selected to be erased in the selection screen 701 shown in FIG. 7 and the processing to erase the object 219 is executed. Of the overlapping objects, the object 219 is erased, while the object 221 representing the two-dimensional code is retained.

### Object Resizing Processing

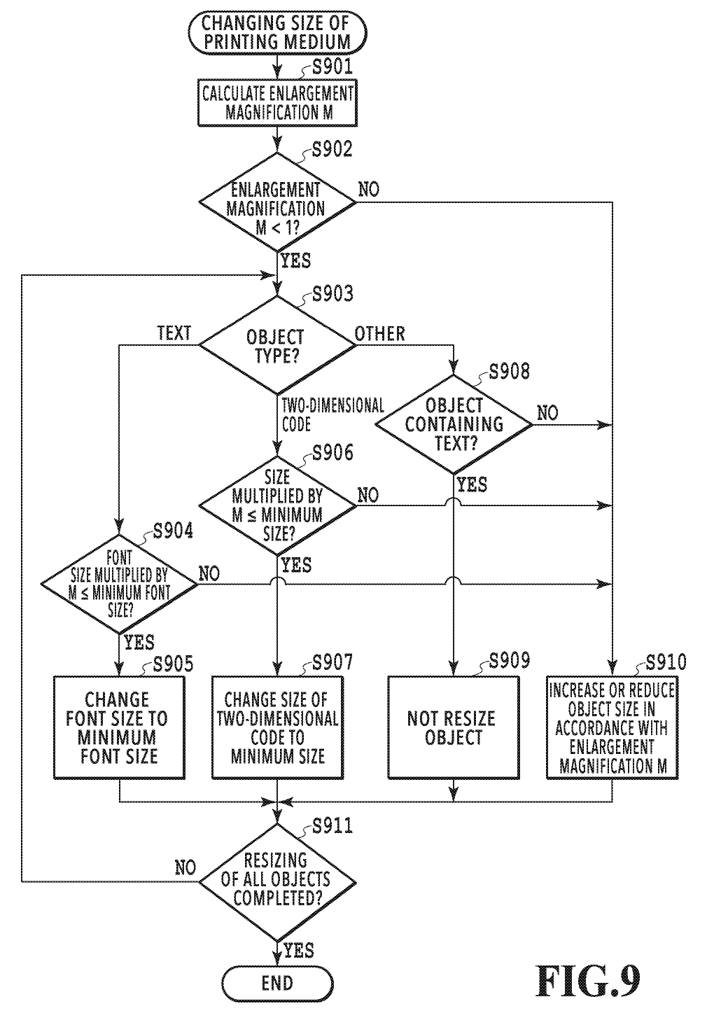

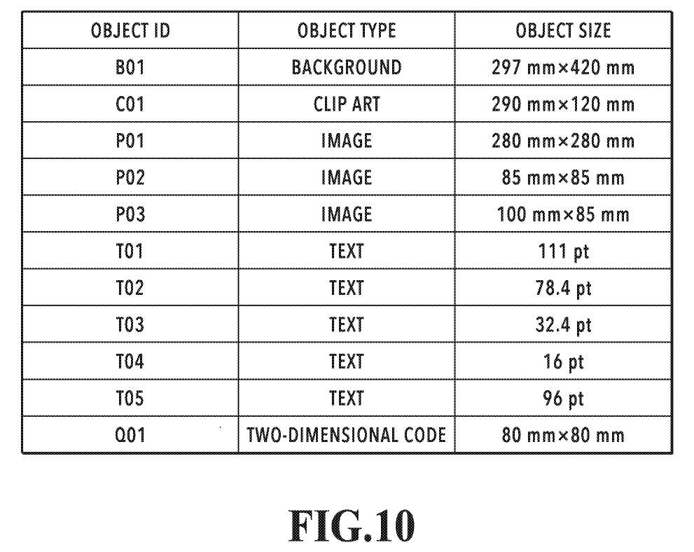

With reference to FIGS. 9 and 10, the object resizing processing executed by the CPU 11 of the client terminal 10 will be described. Specifically, the object resizing processing in the present embodiment is implemented by the CPU 11 executing the client program 17 of the Web browser 14.

FIG. 9 is a flowchart showing an example of the object resizing processing executed by the CPU 11 of the client terminal 10. The processing shown in FIG. 9 is implemented by the CPU 11 of the client terminal 10 loading the program stored in the ROM 12 and the client program 17 into the RAM 13 and executing the programs. Note that some or all of the functions of the steps in FIG. 9 may be implemented by hardware such as an ASIC or electronic circuits. The symbol “S” in the description of each process indicates a step in the flowchart (the same applies to other flowcharts in the present specification). The processing shown in FIG. 9 is started as the user changes the size of the printing medium to be used for printing. For example, the processing shown in FIG. 9 is started as the user selects the printing medium size displayed in the list 310.

In S901, the CPU 11 obtains, via the client program 17, an enlargement magnification M, indicating the magnification of the printing medium size selected in the pull-down menu 234 relative to the currently selected printing medium size. For example, as an example of a method for obtaining the enlargement magnification M, the CPU 11 obtains a horizontal length L1 corresponding to the currently selected printing medium size and a horizontal length L2 corresponding to the printing medium size selected in the pull-down menu 234. The CPU 11 can then obtain the enlargement magnification by dividing the length L2 by the length L1. Here, it is assumed that the CPU 11 obtains a value indicating 0.34 as the horizontal enlargement magnification via the client program 17.

Furthermore, the CPU 11 obtains, via the client program 17, a vertical height H1 corresponding to the currently selected printing medium size and a vertical height H2 corresponding to the printing medium size selected in the pull-down menu 234. The CPU 11 can then obtain the enlargement magnification by dividing the height H2 by the height H1. Here, it is assumed that the CPU 11 obtains a value indicating 0.24 as the vertical enlargement magnification via the client program 17.

In the present embodiment, the smaller value of the horizontal and vertical enlargement magnifications is used. That is, the CPU 11 uses the vertical enlargement magnification of 0.24.

In S902, the CPU 11 determines, via the client program 17, whether the enlargement magnification M obtained in S901 is less than 1. If the CPU 11 determines that the enlargement magnification M is less than 1 (Yes), the processing proceeds to S903. If the CPU 11 determines that the enlargement magnification M is greater than or equal to 1 (No), the processing proceeds to S910. That is, if the CPU 11 determines in S902 that the size of the editing data is reduced in accordance with a change in size of the printing medium, the processing proceeds to S903. If the CPU 11 determines that the size of the editing data is the same or increased, the processing proceeds to S910. The size of the editing data refers to the size of the editing area in the editing data where objects and the like are placed and edited.

In S903, the CPU 11 detects objects, via the client program 17, from the editing data and determines the type of the object to be resized from among the detected objects. For example, as shown in FIG. 9, the CPU 11 determines whether the type of the object to be resized is text, a two-dimensional code, or something other than these. For example, in S903, the CPU 11 can determine the type of the object to be resized, based on the object type as shown in FIG. 10 to be described later.

If the CPU 11 determines in S903 via the client program 17 that the type of the object to be resized is text, the processing proceeds to S904. If the type of the object to be resized is a two-dimensional code, the processing proceeds to S906. Alternatively, if the CPU 11 determines in S903 via the client program 17 that the type of the object to be resized is neither text nor a two-dimensional code, the processing proceeds to S908.

In S904, if the object to be resized is reduced in accordance with the enlargement magnification M, the CPU 11 determines, via the client program 17, whether the font size after the reduction is smaller than a preset minimum font size. The minimum font size indicates the smallest font size of text. If the CPU 11 determines in S904 via the client program 17 that the font size after the reduction is smaller than or the same as the minimum font size after the object to be resized is reduced in accordance with the enlargement magnification M, the processing proceeds to S905. If the CPU 11 determines in S904 via the client program 17 that the font size after the reduction is larger than the minimum font size after the object to be resized is reduced in accordance with the enlargement magnification M, the processing proceeds to S910.

Specifically, if the font size reduced in accordance with the enlargement magnification M is smaller than or equal to the minimum font size, the CPU 11 does not change the font size of the object to be resized to the size corresponding to the enlargement magnification M in S905 to be described later, in terms of text readability.

In S905, the CPU 11 changes the font size of the object to be resized to the minimum font size via the client program 17, and then proceeds to S911. Upon changing the font size of the object to be resized, the CPU 11 may fix the alignment direction of the text of the object and change the font size of the object.

In S906, if the object to be resized is reduced in accordance with the enlargement magnification M, the CPU 11 determines, via the client program 17, whether the size of the reduced object is smaller than a preset minimum size. The minimum size indicates the smallest image size. If the CPU 11 determines in S906 via the client program 17 that the size of the reduced object is smaller than or the same as the minimum size after the object to be resized is reduced in accordance with the enlargement magnification M, the processing proceeds to S907. If the CPU 11 determines in S906 via the client program 17 that the size of the reduced object is larger than the minimum size after the object to be resized is reduced in accordance with the enlargement magnification M, the processing proceeds to S910.

Specifically, if the size of the object reduced in accordance with the enlargement magnification M is smaller than or equal to the minimum size, the CPU 11 does not change the size of the object to be resized to the size corresponding to the enlargement magnification M in S907 to be described later, in terms of readability of the two-dimensional code.

In S907, the CPU 11 changes the size of the object to be resized to the minimum size via the client program 17, and then proceeds to S911. Upon changing the size of the object to be resized, the CPU 11 may change the size of the object around the center of gravity of the object.

In S908, the CPU 11 determines via the client program 17 whether the object to be resized is an object containing text. In the present embodiment, the object containing text is an object different from an object representing text.

For example, the object containing text is an object having text embedded in an image, or an object formed by combining text with other objects. Examples of the object containing text include a map image object containing text indicating a place name, a clip art object of a store logo containing the store name, and the like.

As an example of a determination method for the object containing text, the CPU 11 can determine in S908 whether the object to be resized is an object containing text, by analyzing the object to be resized. For example, this determination can be made using optical character recognition (OCR) technology.

If the CPU 11 determines in S908 via the client program 17 that the object to be resized is the object containing text (Yes), the processing proceeds to S909 where the size of the object is not changed, and then proceeds to S911. If the object to be resized is the object containing text, changing the object in accordance with the enlargement magnification M may make the text contained in the object difficult to read. Particularly, in a case where an object containing text is reduced and editing data containing the object is outputted as an image, such as a poster, the text contained in the image may become difficult to read. In other words, if the object to be resized is the object containing text, in S909, the CPU 11 does not resize the object to be resized, in terms of readability.

If the CPU 11 determines in S908 via the client program 17 that the object to be resized is not the object containing text (No), the processing proceeds to S910.

In S910, the CPU 11 changes the size of the object to be resized, via the client program 17, and then proceeds to S911. For example, if the processing proceeds via S904, the CPU 11 reduces the font size of the object to be resized in accordance with the enlargement magnification M in S910. If the processing proceeds via S906 or S908, the CPU 11 reduces the size of the object to be resized in accordance with the enlargement magnification M in S910. If it is determined in S902 that the enlargement magnification M is greater than or equal to 1 (No), the CPU 11 increases or sets the size of the object to be resized to the same size in accordance with the enlargement magnification M in S910. Upon increasing or setting the size of the object to be resized to the same size, the sizes of all objects contained in the editing data are changed in accordance with the enlargement magnification M.

In S911, the CPU 11 determines via the client program 17 whether resizing of all objects contained in the editing data is completed. If the CPU 11 determines in S911 via the client program 17 that the resizing of all objects is not completed (No), the processing proceeds to S903, and repeats the processing from S903 to S910 until the resizing of all objects is completed. If the CPU 11 determines in S911 via the client program 17 that the resizing of all objects is completed (Yes), the processing shown in FIG. 9 ends. This completes the processing flow for resizing objects contained in the editing data.

FIG. 10 is a diagram showing an example of a method for saving and managing objects contained in editing data in the client program 17. In the present embodiment, the client program 17 uses a management table as shown in FIG. 10 to manage objects contained in the editing data. In the management table shown in FIG. 10, object IDs, object types, and object sizes are linked to each other.

The object ID is an identifier for uniquely identifying an object. For example, each of the objects 211 to 221 shown in FIGS. 2 to 8 has a corresponding object ID. For example, the object 221 representing a two-dimensional code has an object ID of Q01.

The object type indicates the type of an object. The object size indicates the size of an object contained in the editing data. For example, FIG. 10 shows that a clip art object with an object ID of C01 has the size of a 290 mm×120 mm rectangular area. Note that the shape of an object contained in the editing data does not have to match the shape of the rectangular area indicated by the object size. For example, even if an object representing an image has a circular shape, the object size of that object may be managed as a rectangular area in the management table. In other words, the object size in the management table is an expediential size set for managing objects in the editing data.

Here, description will be given of the object resizing processing shown in FIG. 9, in a case where, for example, square (100 mm×100 mm) is selected in FIG. 3 and the printing medium size is changed from A3 to square (100 mm×100 mm). FIG. 10 shows, for example, that an object with an object ID B01 is an object representing background and has the size of 297 mm×420 mm. In the present embodiment, the minimum font size and the minimum size of the two-dimensional code are predetermined to be 8 pt and 20 mm×20 mm, respectively. It is assumed here that an object representing text with an object ID of T04 shown in FIG. 10 is the object to be resized. In this case, in S904, the CPU 11 compares, via the client program 17, 3.84 pt with the minimum font size of 8 pt. 3.84 pt is the font size obtained by multiplying the font size 16 pt of the object representing text by 0.24. The CPU 11 then determines via the client program 17 that the minimum font size is larger. Therefore, in S905, the CPU 11 changes the font size of the object representing text to the minimum font size of 8 pt via the client program 17. Note that the minimum font size or minimum size may also be predetermined for the object types other than text and two-dimensional code.

A case is also assumed where the object representing a two-dimensional code with the object ID of Q01 shown in FIG. 10 is the object to be resized. In this case, in S906, the CPU 11 compares, via the client program 17, the size 19.2 mm×19.2 mm with the minimum size of 20 mm×20 mm. The size 19.2 mm×19.2 mm is the size obtained by multiplying the size 80 mm×80 mm of the object representing the two-dimensional code by 0.24. The CPU 11 then determines via the client program 17 that the minimum size is larger. Therefore, in S907 of FIG. 9, the CPU 11 changes, via the client program 17, the size of the object representing the two-dimensional code to the minimum size of 20 mm×20 mm.

Furthermore, a case is assumed where an object representing an image with an object ID of P03 shown in FIG. 10 is to be resized. In this case, the CPU 11 determines in S908 via the client program 17 whether the object representing the image is an object containing text. Then, in S909, the CPU 11 does not resize the object via the client program 17 if it is determined in S908 that the object to be resized is the object containing text. In S909, the CPU 11 changes the size of the object in accordance with the enlargement magnification M via the client program 17 if it is determined in S908 that the object to be resized is not the object containing text. By performing the above-described resizing processing for each object, it is possible to obtain an editing data layout in which the font size of all objects representing text is larger than or equal to the minimum font size, and the size of the object representing the two-dimensional code is larger than or equal to the minimum size.

### Erasure Candidate Selection Processing

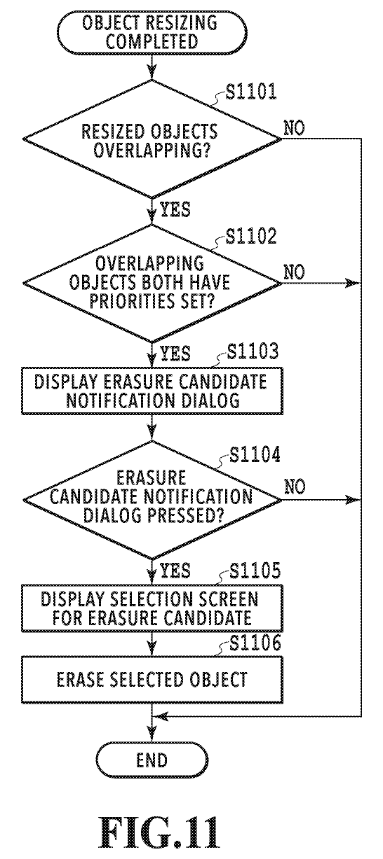

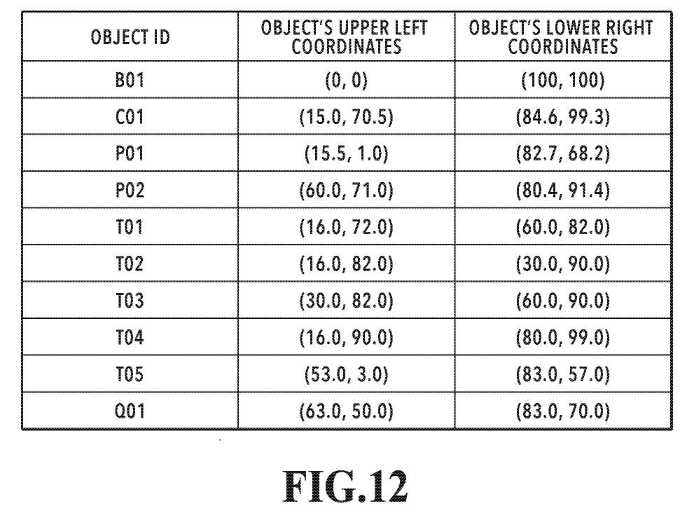

Erasure candidate selection processing will be described with reference to FIGS. 11 and 12. FIG. 11 is a flowchart illustrating an example of the erasure candidate selection processing executed by the CPU 11 upon completion of the object resizing processing. The processing shown in FIG. 11 is started as the user changes the size of the printing medium and the object resizing processing shown in FIG. 9 is completed.

In S1101, the CPU 11 determines via the client program 17 whether objects contained in the resized editing data overlap with each other. If the CPU 11 determines in S1101 via the client program 17 that objects contained in the resized editing data overlap with each other (Yes), the processing proceeds to S1102. If the CPU 11 determines in S1101 via the client program 17 that objects contained in the resized editing data do not overlap with each other (No), this flow ends.

Specifically, even if objects contained in the editing data before resizing (for example, before execution of the resizing processing shown in FIG. 9) overlap with each other, the CPU 11 does not execute the processing from S1102 onwards via the client program 17 in S1101. In other words, in such a case, the CPU 11 does not display an erasure candidate notification dialog in S1103 to be described later, or does not display a selection screen in S1105 to be described later.

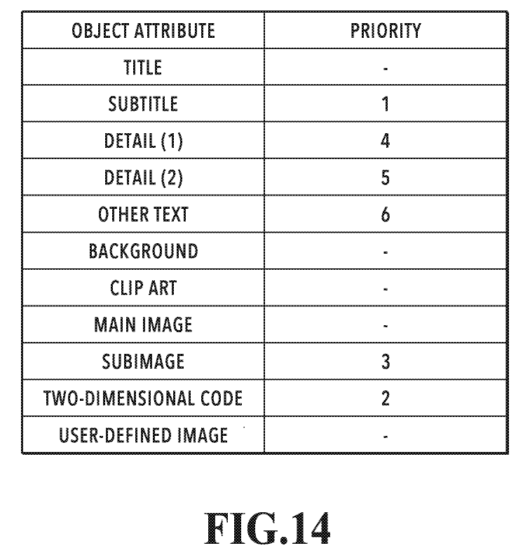

In S1102, the CPU 11 determines via the client program 17 whether priorities are set for attributes of the overlapping objects, based on object attributes and priorities corresponding to the object attributes to be described later. If the CPU 11 determines in S1102 via the client program 17 that the priorities are set for the attributes of the overlapping objects (Yes), the processing proceeds to S1103. If the CPU 11 determines in S1102 via the client program 17 that the priorities are not set for the attributes of the overlapping objects (No), this flow ends. For example, in S1102, the CPU 11 can determine whether the priorities are set for the attributes of the overlapping objects, by obtaining priority information corresponding to object attributes as shown in FIG. 14 to be described later.

In the present embodiment, description will be given of, but not limited to, an example where two of a plurality of objects contained in the editing data overlap with each other and priorities are set for the attributes of both objects. For example, if three or more objects overlap with each other and priorities are set for the attributes of these objects, the erasure candidate selection processing of the present embodiment can be applied.

In S1103, the CPU 11 displays an erasure candidate notification dialog via the client program 17, and proceeds to S1104. For example, if the resized object 218 representing text and the resized object 213 representing an image overlap with each other and both have priorities set, the CPU 11 displays an erasure candidate notification dialog 411 as shown in FIG. 4. If no priorities are set for the attributes of any of the overlapping objects, the CPU 11 does not display the erasure candidate notification dialog. Specifically, if there are two overlapping objects and no priorities are set for the attributes of either one of these objects, the CPU 11 does not display the erasure candidate notification dialog.

Here, a case is assumed where there are three overlapping objects, one of which has no priorities set for its attributes, and the remaining two objects have priorities set for their attributes. In this case, the CPU 11 displays erasure candidate notification dialogs for the two objects having the priorities set for their attributes. In a case where there are three overlapping objects and all of these objects have priorities set for their attributes, the CPU 11 can display erasure candidate notification dialogs for all three objects.

Text placed on clip art before resizing is largely unaffected even if it overlaps with the clip art after resizing. For this reason, in the present embodiment, the CPU 11 can control via the client program 17 not to display the erasure candidate notification dialog and not to perform object erasure processing. This control can be implemented, for example, by not setting priorities for the attributes of the object representing the clip art. A method for setting priorities according to object attributes will be described in detail later.

In S1104, the CPU 11 determines via the client program 17 whether the erasure candidate notification dialog is pressed. If the CPU 11 determines in S1104 via the client program 17 that the erasure candidate notification dialog is pressed (Yes), the processing proceeds to S1105. If the CPU 11 determines that the erasure candidate notification dialog is not pressed (No), this flow ends.

In S1105, the CPU 11 displays, via the client program 17, a selection screen for selecting an erasure candidate as the erasure candidate notification dialog is pressed, and then proceeds to S1106. For example, the selection screen 501 as shown in FIG. 5 is displayed as the erasure candidate notification dialog 411 is pressed in FIG. 4. The user performs a selection operation to select the object to be erased from among the overlapping objects displayed in the selection screen 501.

In S1106, as the object to be erased is selected, the CPU 11 erases the designated object via the client program 17. Note that the object erasure processing in the present embodiment is not limited thereto. For example, in S1106, the CPU 11 may automatically erase, via the client program 17, an object with lower priorities from among detected overlapping objects. This allows each object contained in the editing data to be automatically resized to a size suitable for the size of the printing medium in a case where the size of the editing data is changed with a change in the size of the printing medium.

According to the present disclosure, the layout of overlapping objects contained in editing data can be adjusted in the print product creation application such as the poster creation application. That is, in a case where the size of editing data is changed and objects contained in the editing data overlap with each other, the client program can display an erasure candidate notification to notify the user that the objects are overlapping. The user then performs an operation in response to the erasure candidate notification displayed as an item. Furthermore, the user can adjust the layout of the overlapping objects via a selection screen displayed according to the operation in response to the erasure candidate notification.

FIG. 12 shows an example of a method for saving and managing coordinates of each object contained in editing data after resizing, as a method for the client program 17 to detect overlapping objects among a plurality of objects contained in the editing data.

In a management table of FIG. 12, an object ID, object’s upper left coordinates, and object’s lower right coordinates are linked to each other. The object ID in FIG. 12 is an identifier for uniquely identifying an object. The object’s upper left coordinates are upper left vertex coordinates of a rectangular area of an object contained in the editing data in a case where upper left vertex coordinates of the rectangular editing data are used as a reference point. The object’s lower right coordinates are lower right vertex coordinates of the rectangular area of the object contained in the editing data in a case where the upper left vertex coordinates of the rectangular editing data are used as the reference point. For example, a case is assumed where, as shown in FIG. 4, the size of the printing medium is changed from A3 to square (100 mm×100 mm) and then the resizing of the objects contained in the editing data is completed. The vertex coordinates of the rectangular areas of each object in S1101 of FIG. 11 described above are as shown in FIG. 12. In this case, an object with an object ID of P02 and an object with an object Id of T04 overlap in the x-coordinate range of 60.0 to 80.0 and in the y-coordinate range of 90.0 to 91.4. In this way, the CPU 11 can detect, via the client program 17, overlapping of objects contained in the editing data by referring to the table as shown in FIG. 12.

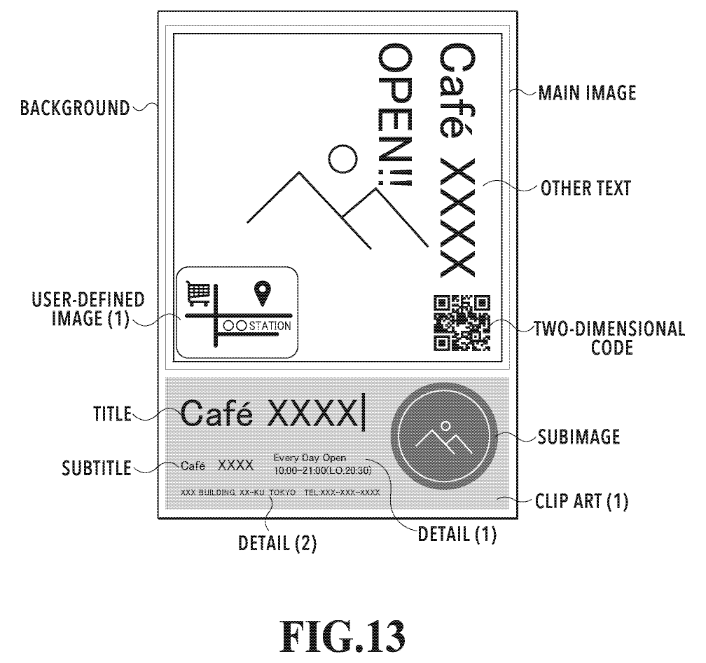

FIG. 13 is a diagram showing an example of a poster created based on a template in the Web application 21 and object attributes preset for objects contained in the template. FIG. 13 shows the object attributes preset for each of the objects contained in the editing data shown in FIG. 2, for example. With reference to FIGS. 2 and 13, the object 213 representing an image has an attribute “subimage” and the object 218 representing text has an attribute “detail (2).”

FIG. 14 is a diagram showing an example of a method for storing and managing priorities according to the object attributes. In a management table of FIG. 14, the object attributes are linked to the priorities. The object attributes in FIG. 14 indicate the attributes set for the objects contained in the editing data. The priorities in FIG. 14 indicate the priorities corresponding to the object attributes. In S1102 of FIG. 11 described above, the CPU 11 can determine, via the client program 17, that the priorities are set for both the object 213 and the object 218 by referring to FIG. 14.

In FIG. 14, smaller values set for the priorities indicate higher priorities. For example, according to FIG. 14, the object 213 having the object attribute “subimage” has the priority of 3, while the object 218 having the object attribute “detail (2)” has the priority of 5. In other words, according to FIG. 14, the object 213 having the object attribute “subimage” has a higher priority than the object 218 having the object attribute “detail (2)”. Furthermore, the priorities corresponding to the object attributes can be set in an incremental fashion, as shown in FIG. 14.

In FIG. 14, priorities corresponding to object attributes for which no priorities are set are each indicated by a hyphen, indicating that no priorities are set. For example, according to FIG. 14, no priority is set to the clip art object attribute. The list shown in FIG. 14 is updated in response to the setting of priorities to be described later.

### Priority Corresponding to Object Attribute

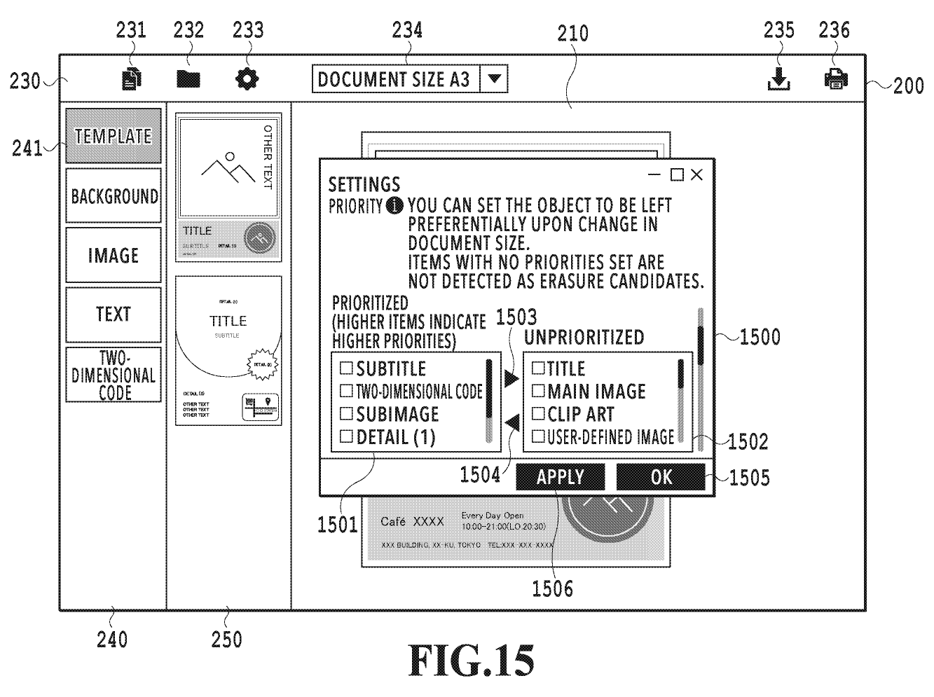

Next, a method for setting priorities corresponding to the attributes of each object contained in the editing data will be described with reference to FIG. 15.

FIG. 15 is a diagram showing an example of the Web application editing screen 200, in which a settings screen 1500 is displayed for setting priorities corresponding to object attributes. As the user presses the setting button 233, the client program 17 displays the settings screen 1500. The settings screen 1500 displays a prioritized attribute list 1501 and an unprioritized attribute list 1502. The prioritized attribute list 1501 displays the object attributes for which the priorities are set. The unprioritized attribute list 1502 displays the object attributes for which no priorities are set.

The prioritized attribute list 1501 or the unprioritized attribute list 1502 includes check boxes for receiving the selection of the object attributes displayed in the list. The settings screen 1500 is also provided with move buttons 1503 and 1504, as well as an OK button 1505 and an apply button 1506, which will be described later.

The higher the object attribute located in the prioritized attribute list 1501, the higher the priority set for that object attribute. The user selects any object attribute in the prioritized attribute list 1501 and presses the move button 1503 to move the selected object attribute from the prioritized attribute list 1501 to the unprioritized attribute list 1502. The user can thus configure the settings that no priority is set for the selected object attribute, by pressing the apply button 1506.

Conversely, the user selects any object attribute in the unprioritized attribute list 1502 and presses the move button 1504 to move the selected object attribute from the unprioritized attribute list 1502 to the prioritized attribute list 1501. The user can thus set a priority for the selected object attribute by pressing the apply button 1506. Upon detection of the pressing of the OK button 1505 by the user, the client program 17 closes the settings screen 1500.

### Other Embodiments

While the preferred embodiment of the present disclosure has been described, it goes without saying that the present disclosure is not limited to this embodiment, and various modifications and variations are possible within the spirit and scope of the present disclosure. The various features of the above-described embodiment may be used individually or in combination.

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Furthermore, not only are the functions of the above-described embodiment(s) realized by the computer executing the program code read out, but the OS running on the computer may also perform some or all of the actual processing based on the instructions of the program code. It goes without saying that this also includes cases where the functions of the above-described embodiment(s) are realized by this processing.

Furthermore, it goes without saying that this also includes cases where the program code read from the storage medium is written into a memory on a function expansion board inserted into the computer or on a function expansion unit connected to the computer. Then, based on the instructions of the written program code, a CPU or the like on the function expansion board or function expansion unit performs some or all of the actual processing, and this processing also realizes the functions of the above-described embodiment(s).

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2024-205613, which was filed on November 26, 2024 and which is hereby incorporated by reference herein in its entirety.

What is claimed is:

1. A non-transitory computer-readable storage medium storing a program of an application for causing an information processing apparatus to execute a method, the method comprising:
changing a size of an editing area of editing data in response to a change in a size of a printing medium used to output the editing data in the application, the editing data containing a first object and a second object different from the first object; and
performing control to notify that the first object and the second object overlap in a case where the first object and the second object overlap as the size of the editing area is changed by the changing.

2. The storage medium according to claim 1, wherein the method further comprises receiving the change in the size of the printing medium in the application.

3. The storage medium according to claim 2, wherein a value indicating a minimum size of the first object and a value indicating a minimum size of the second object are set for the first object and the second object.

4. The storage medium according to claim 3, wherein the value indicating the minimum size of the first object differs depending on a type of the first object and the value indicating the minimum size of the second object differs depending on a type of the second object.

5. The storage medium according to claim 4, wherein the changing includes changing the size of the editing area based on a magnification of the size of the printing medium after receiving the change in the size of the printing medium by the receiving, relative to the size of the printing medium before receiving the change in the size of the printing medium by the receiving.

6. The storage medium according to claim 5, wherein
the changing includes
if the change in the size of the editing area causes the first object to be changed to a size smaller than or equal to the value indicating the minimum size of the first object, changing the first object to the size indicated by the value indicating the minimum size of the first object,
if the change in the size of the editing area causes the second object to be changed to a size smaller than or equal to the value indicating the minimum size of the second object, changing the second object to the size indicated by the value indicating the minimum size of the second object, and
if the change in the size of the editing area causes the first object to be changed to a size larger than the value indicating the minimum size of the first object and causes the second object to be changed to a size larger than the value indicating the minimum size of the second object, changing the first object and the second object in accordance with the magnification.

7. The storage medium according to claim 6, wherein the first object and the second object are either an object representing text or an object representing a two-dimensional code.

8. The storage medium according to claim 1, wherein the change in the size of the editing area performed by the changing is reducing the size of the editing area.

9. The storage medium according to claim 1, wherein the method further comprises:
obtaining information indicating whether priorities are set for attributes of each of the first object and the second object, and
wherein the performing control includes giving a notification based on the information.

10. The storage medium according to claim 9, wherein the performing control includes giving the notification if the priorities are set for both of the attributes of the first object and the second object.

11. The storage medium according to claim 10, wherein
the priorities include different priorities that are set for each of the attributes, and
the performing control further includes performing control to erase, from the editing data, one of the first object and the second object, having the attribute with a lower priority based on the information.

12. The storage medium according to claim 11, wherein the performing control further includes performing control to display a settings screen in which at least one of the priorities can be set in accordance with a user’s operation.

13. The storage medium according to claim 12, wherein the priorities can be set in accordance with the attributes of the first object and the second object.

14. The storage medium according to claim 1, wherein
the performing control includes
performing control to display an item for a notification, and
further performing control to display a selection screen in which one item of the first object and the second object can be selected to be erased in accordance with a user’s operation on the one item.

15. The storage medium according to claim 14, wherein the performing control further includes performing control to erase the selected object, based on a user’s operation on the selection screen to select the object to be erased.

16. The storage medium according to claim 1, wherein
the first object has a respective rectangular area indicating a size of the first object,
the second object has a respective rectangular area indicating a size of the second object, and
the performing control further includes performing control to detect overlapping of the first object and the second object, based on vertex coordinates of the respective rectangular area for each of the first object and the second object.

17. The storage medium according to claim 2, wherein the performing control does not include giving a notification even if the first object and the second object overlap in the editing data before the change in the size of the printing medium is received by the receiving.

18. An information processing apparatus configured to execute an application, the information processing apparatus comprising:
at least one memory and at least one processor that are configured to:
change a size of an editing area of editing data in response to a change in a size of a printing medium used to output the editing data in the application, the editing data containing a first object and a second object different from the first object; and
perform control to notify that the first object and the second object overlap in a case where the first object and the second object overlap as the size of the editing area is changed by the first change unit.

19. A method for controlling an information processing apparatus configured to executes an application, the method comprising:
changing a size of an editing area of editing data in response to a change in a size of a printing medium used to output the editing data in the application, the editing data containing a first object and a second object different from the first object; and
performing control to notify that the first object and the second object overlap in a case where the first object and the second object overlap as the size of the editing area is changed by the changing.
